(19) United States
(12) Patent Application Publication
(10) Pub. No.: US 2013/0043341 A1
(43) Pub. Date: Feb. 21, 2013

(54) Self-Powered Air-Floating Carrier with an Adjustable Height

(71) Applicants: Chang-Hsien Tai, Neipu Hsiang (TW); Jr-Ming Miao, Neipu Hsiang (TW); Uzu-Kuei Hsu, Neipu Hsiang (TW)

(72) Inventors: Chang-Hsien Tai, Neipu Hsiang (TW); Jr-Ming Miao, Neipu Hsiang (TW); Uzu-Kuei Hsu, Neipu Hsiang (TW)

(21) Appl. No.: 13/280,510

(22) Filed: Oct. 25, 2011

(30) Foreign Application Priority Data
Aug. 18, 2011 (TW) 100129566

(51) Int. Cl. B64B 1/00; B64B 1/50

(52) U.S. Cl. 244/30

(57) ABSTRACT

A self-powered air-floating carrier includes a floating body having a compartment. A pressure resistant member is mounted in the compartment of the floating body. The pressure resistant member includes a chamber and an adjusting assembly mounted to a peripheral wall of the pressure resistant member. The adjusting assembly communicates the chamber of the pressure resistant member with the compartment of the floating body, allowing exchange of a gas in the chamber and a gas in the compartment. The pressure resistant member is covered by an insulating layer. A temperature controlling unit is connected to the floating body. The temperature controlling unit controls a temperature in the chamber of the pressure resistant member.

### BACKGROUND OF THE INVENTION

1. Field of the Invention

The present invention relates to an air-floating carrier and, more particularly, to a self-powered air-floating carrier that can move upward or downward according to need and that can stably stay in the air.

2. Description of the Related Art

Conventional air-floating carriers, such as flying boats and balloons, generally include a chamber filled with an uprising gas lighter than the air to provide suitable floating force so as to keep the air-floating carries staying in the upper air. The chamber is generally filled with helium that is liable to change in pressure and temperature due to the altitude of the air-floating carrier and/or a change in the upper-air climate, causing a change in the volume of the helium resulting from heat expansion or shrinkage, such that the floating force provided by the helium may not be able to keep the air-floating carrier at the desired height. Furthermore, the air-floating carrier can not carry other articles, providing limited utility during the operation of the air-floating carrier in the upper air.

Taiwan Patent Publication No. 200736115 discloses a system providing aerostatical uprising force to control a flying boat. The ratio of the air to the uprising gas in the flying boat is controlled through compressing and/or releasing pressure of the uprising gas or the internal air so as to control the overall weight of the flying boat.

Although the aerostatical uprising force for the flying boat can be adjusted by controlling the pressure difference between the internal air and the ambient air, an active density-controlled buoyant system (DCB) is required to proceed with the compression and/or pressure release. Thus, the height of the flying boat can not be stably controlled through an active control mode, let alone carrying articles (such as power supply devices, heat collecting devices, or the like) by the flying boat. The utility of the air-floating carrier is, thus, not improved.

Furthermore, the abundant natural energy (such as the solar energy and the wind energy) in the upper air is not effectively used. As an example, the air-floating can not carry any solar energy collecting devices. Namely, the solar energy collecting devices can not operate at a location near the sun and, thus, have limited effect in collecting the sunlight and the solar heat. Thus, the solar energy collecting devices can only be mounted on the ground or roofs and occupy a considerable space, failing to provide the best electricity generating efficiency.

Thus, a need exist for a self-powered air-floating carrier that carry a solar energy collecting device to solve the above-mentioned disadvantages.

### SUMMARY OF THE INVENTION

An objective of the present invention is to solve the above-mentioned disadvantages by providing a self-powered air-floating carrier that can move upward or downward according to need and that can stably stay in the air.

Another objective of the present invention is to provide a self-powered air-floating carrier that can carry articles for collecting natural energy for use, enhancing the utility of the operation in the upper air and eliminating the limitation to the installation on the ground.

The present invention fulfills the above objectives by providing a self-powered air-floating carrier including a floating body having a compartment. A pressure resistant member is mounted in the compartment of the floating body. The pressure resistant member includes a chamber and an adjusting assembly mounted to a peripheral wall of the pressure resistant member. The adjusting assembly communicates the chamber of the pressure resistant member with the compartment of the floating body, allowing exchange of a gas in the chamber and a gas in the compartment. The pressure resistant member is covered by an insulating layer. A temperature controlling unit is connected to the floating body. The temperature controlling unit controls a temperature in the chamber of the pressure resistant member.

The floating body further includes a support having first and second ends. A ball-shaped member is coupled to the first end of the support and fixed to an outer periphery of the floating body. The second end of the support is adapted to be fixed to a ground. The support draws the floating body. The support includes a steel rope containing a cable.

The adjusting assembly includes an exhaust valve, an inlet valve, and a pump. The exhaust valve includes two ends respectively in communication with the chamber of the pressure resistant member and the compartment of the floating body. The inlet valve includes two ends respectively in communication with the compartment of the floating body and the chamber of the pressure resistant member. The pump is connected the inlet valve.

The adjusting assembly further includes two sensors respectively connected to two sides of the pump. The sensors are respectively located in the chamber and the compartment.

The temperature controlling unit includes a heat collection member and a heating member. The heat collection member is mounted to the outer periphery of the floating body. The heating member extends into the chamber of the pressure resistant member and abuts the inner periphery of the pressure resistant member.

The insulating layer is annularly located on the outer periphery of the pressure resistant member and is made of thermally insulating material or structure.

A bracket unit is mounted to the pressure resistant member and includes a first end carrying the pressure resistant member. A second end of the bracket unit is fixed to the inner periphery of the floating body at a location corresponding to the support.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a cross sectional view of a self-powered air-floating carrier according to the present invention.

FIG. 2 shows a cross sectional view illustrating operation of the self-powered air-floating carrier according to the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “upper”, “inner”, “outer”, “side”, “upward”, “downward”, “height”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

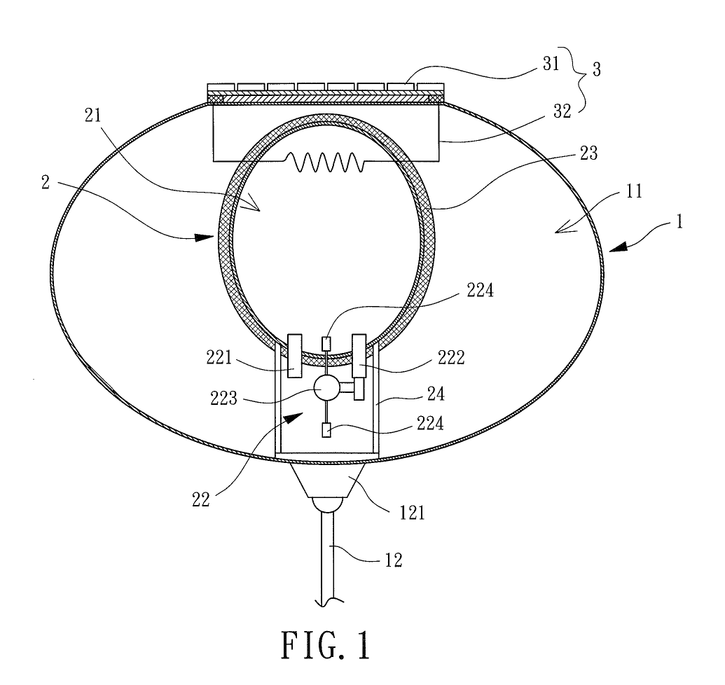

FIG. 1 illustrates an embodiment of a self-powered air-floating carrier according to the present invention. According to the form shown, the self-powered air-floating carrier includes a floating body 1, a pressure resistant member 2 and a temperature controlling unit 3. The pressure resistant member 2 is mounted in the floating body 1. The temperature controlling unit 3 is connected to the floating body 1 and supplies heat to the pressure resistant member 2.

The floating body 1 is a soft object, such as a rubber balloon, for receiving an uprising gas having a density smaller than the air and having high safety. Preferably, the floating body 1 is filled with helium to provide the floating body 1 with suitable floating force to float in the air. Specifically, the floating body 1 includes a compartment 11 receiving the uprising gas at normal temperature/normal pressure to create strong floating force for keeping the floating body 1 floated in the air. The floating body 1 further includes a support 12 connected to the ground for drawing the floating body 1. Preferably, the support 12 includes a steel rope containing a cable (not shown) and includes first and second ends. The second end of the support 12 is fixed to the ground. A ball-shaped member 121 is coupled to the first end of the support 12 and preferably fixed to an outer periphery of the floating body 1 and particularly to a bottom side of the floating body 1 (FIG. 1). Thus, the floating body 1 can be stably supported by the support 12.

The pressure resistant member 2 can be any container made of a material capable of resisting high temperature and high pressure and is preferably made of lightweight alloy or lightweight steel article of manufacture to resist the impact of the high temperature/high pressure gas. Preferably, the pressure resistant member 2 can be configured corresponding to the outline of the floating body 1.

The pressure resistant member 2 is mounted in the compartment 11 of the floating body 1 and includes a chamber 21 receiving an uprising gas the same as that received in the compartment 11. Preferably, the chamber 21 is filled with high temperature/high pressure helium for balancing the pressure and temperature of the gas in the compartment 11. The pressure resistant member 2 further includes an adjusting assembly 22 mounted to a peripheral wall of the pressure resistant member 2 for communicating the chamber 21 of the pressure resistant member 2 with the compartment 11 of the floating body 1, allowing exchange of the gas in the chamber 21 and the gas in the compartment 11. In this embodiment, the adjusting assembly 22 includes an exhaust valve 221, an inlet valve 222 and a pump 223. Two ends of the exhaust valve 221 are respectively in communication with the chamber 21 of the pressure resistant member 2 and the compartment 11 of the floating body 1 for releasing the gas in the chamber 21. Two ends of the inlet valve 222 are respectively in communication with the compartment 11 of the floating body 1 and the chamber 21 of the pressure resistant member 2. The inlet valve 222 is connected to the pump 223. Low temperature gas in the compartment 11 is pumped by the pump 223 through the inlet valve 222 into the chamber 21 and is heated in the chamber 21. Furthermore, the adjusting assembly 22 includes at least one sensor 224 preferably coupled to a side of the pump 223 for detecting the pressure and temperature of the gas in the compartment 11 of the floating body 1. In this embodiment, two sensors 224 are coupled to two sides of the pump 223 and respectively located in the chamber 21 and the compartment 11 for detecting the pressure and temperature in the chamber 21 and the compartment 1. The sensors 224 are preferably sensor actuators to actuate the pump 223 to draw in the gas through the inlet valve 222.

The pressure resistant member 2 is covered by an insulating layer 23 to prevent from heat loss of the gas in the chamber 21 of the pressure resistant member 2. In this embodiment, the insulating layer 23 is annularly provided on the outer periphery of the pressure resistant member 2 and made of vacuum insulating material to achieve better heat insulating effect. The pressure resistant member 2 can be loaded in the compartment 11 of the floating body 1 by any suitable provisions such as mounting and suspension. In this embodiment, a bracket unit 24 including an end for carrying the pressure resistant member 2 is provided. The other end of the bracket unit 24 is fixed to the inner periphery of the floating body 1 at a location corresponding to the support 12. The bracket unit 24 provides the pressure resistant member 2 with better support to avoid the pressure resistant member 2 from swaying in the compartment 11.

The temperature controlling unit 3 is connected to the floating body 1 and supplies heat to the gas filled in the chamber 21 of the pressure resistant member 2. In this embodiment, the temperature controlling unit 3 includes a heat collection member 31 and a heating member 32. The heat collection member 31 is mounted to the outer periphery of the floating body 1. The heat collection member 31 can be fixed to a top face (see FIG. 1) of the floating body 1 by such as bonding, gluing, etc so as to directly absorb and use the solar heat. The heat collection member 31 is preferably comprised of a plurality of solar plates arranged in a matrix to enhance the solar energy absorbing efficiency or comprised of a plane array type funnel-shaped solar energy exchanger to enhance the overall solar heat absorbing efficiency.

The heating member 32 is connected to the chamber 21 of the pressure resistant member 2 and converts a portion of the solar energy absorbed by the heat collection member 31 into heat, which is used to heat the gas filled in the chamber 21 of the pressure resistant member 2. In this embodiment, the heating member 32 extends into the chamber 21 and abuts with the inner periphery of the pressure resistant member 2, avoiding heat loss from the mounting area of the heating member 32.

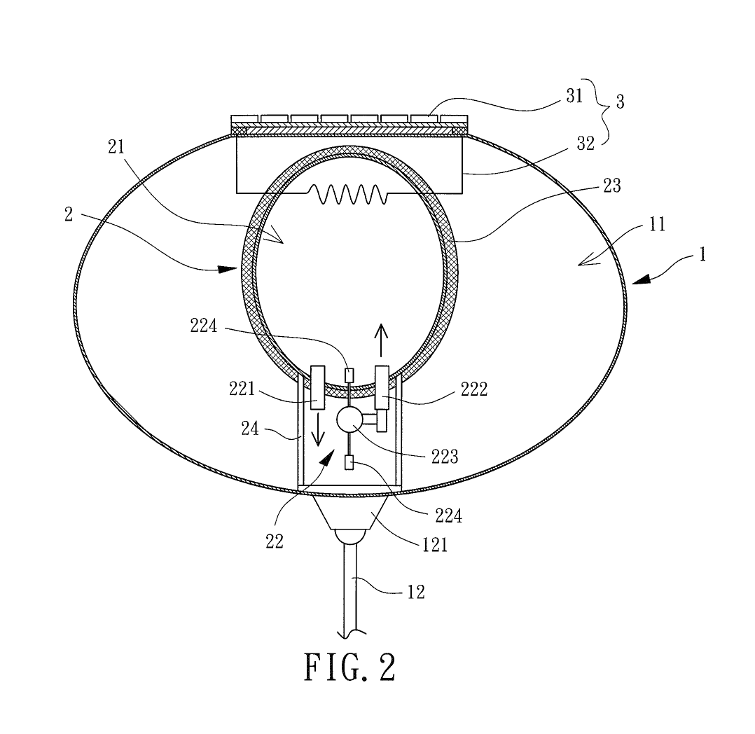

With reference to FIG. 2, in use of the self-powered air-floating carrier according to the present invention, the compartment 11 of the air-floating body 1 is filled with normal temperature/normal pressure helium, and the chamber 21 of the pressure resistant body 2 is filled with high temperature/high pressure helium. Due to the density of helium lower than the air and due to the floating force provided by the volumes of the floating body 1 and the chamber 21, the self-powered air-floating carrier can slowly rise into the upper air, with the support 12 guiding the drifting direction of the self-powered air-floating carrier in the upper air.

The temperature difference between the helium in the floating body 1 and the ambient air can affect the floating force of the self-powered air-floating carrier. After the self-powered air-floating carrier has stayed in the upper air for a period of time and when a balance is reached between an interior of the floating body 1 and the ambience, one of the sensors 224 detects the temperature and pressure of helium in the compartment 11 and obtain a relative temperature value that is compared with a temperature range of the self-powered air-floating carrier at differing heights. The switch of the inlet valve 222 is actuated to draw the low temperature helium in the compartment 11 into the chamber 21 by the pump 223. The high temperature helium in the chamber 21 is replaced by the low temperature helium due to the pressure difference and is discharged to the compartment 11. The temperature in the compartment 11 can be increased to provide a larger temperature difference to the ambience, maintaining or changing the floating force of the self-powered air-floating carrier so that the self-powered air-floating carrier can stay at or move upward or downward to a suitable height. At the same time, the low temperature helium introduced into the chamber 21 can be heated by the heating member 32 to a high temperature/high pressure state, and through continuous absorption of the solar energy and conversion into heat energy by the heat collection member 31, the heating efficiency of the heating member 32 to the chamber 21 can be maintained, reliably maintaining the helium in the chamber 21 in the high temperature/high pressure state. On the other hand, when the high temperature/high pressure helium in the chamber 21 of the pressure resistant member 2 reaches its saturated state, the high temperature/high temperature helium directly actuates the exhaust valve 221 to discharge the high temperature/high pressure helium into the compartment 11. Furthermore, through detection by the other sensor 24 detecting the temperature and pressure of the gas in the chamber 21, the inlet valve 222 can be opened to draw low temperature gas into the compartment 11 by the pump 223. Thus, the temperature and pressure of the gas in the pressure resistant member 2 is balanced.

In view of the foregoing, the self-powered air-floating carrier according to the present invention can carry the temperature controlling unit 3 to absorb the solar energy in the upper air, and the heat energy converted from the absorbed solar energy can be used by the heating member 32 to heat the gas in the chamber 21 of the pressure resistant member 2 so as to maintain the gas in the pressure resistant member 2 in the high temperature/high pressure state. Furthermore, through detection by the sensors 24, timely exchange of the gas in the compartment 11 and the gas in the chamber 21 is conducted to provide an adjustment mechanism for the self-powered air-floating carrier, providing the self-powered air-floating carrier with better floating force so that the self-powered air-floating carrier according to the present invention can stably stay at the suitable height. Further, through the active height adjustment mechanism, the self-powered air-floating carrier can carry articles for collecting natural energy for use, eliminating the limitation to the installation on the ground and enhancing the utility of the operation in the upper air. Use of the reusable energy can be further enhanced.

In the self-powered air-floating carrier according to the present invention, through exchange of high temperature gas and low temperature gas, the temperature difference between the gas in the self-powered air-floating carrier and the ambience can be maintained, so that the self-powered air-floating carrier can be actively controlled to move upward or downward, allowing the self-powered air-floating carrier to stably stay in the upper air.

In the self-powered air-floating carrier according to the present invention, the self-powered air-floating carrier can carry articles for collecting natural energy for use, enhancing the utility of the operation in the upper air and eliminating the limitation to the installation on the ground.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A self-powered air-floating carrier comprising:
a floating body including a compartment;
a pressure resistant member mounted in the compartment of the floating body, with the pressure resistant member including a chamber and an adjusting assembly mounted to a peripheral wall of the pressure resistant member, with the adjusting assembly communicating the chamber of the pressure resistant member with the compartment of the floating body, allowing exchange of a gas in the chamber and a gas in the compartment, with the pressure resistant member covered by an insulating layer; and
a temperature controlling unit connected to the floating body, with the temperature controlling unit controlling a temperature in the chamber of the pressure resistant member.

2. The self-powered air-floating carrier as claimed in claim 1, with the floating body further including a support having first and second ends, with a ball-shaped member coupled to the first end of the support and fixed to an outer periphery of the floating body, with the second end of the support adapted to be fixed to a ground, with the support drawing the floating body, with the support including a steel rope containing a cable.

3. The self-powered air-floating carrier as claimed in claim 1, with the adjusting assembly including an exhaust valve, an inlet valve and a pump, with the exhaust valve including two ends respectively in communication with the chamber of the pressure resistant member and the compartment of the floating body, with the inlet valve including two ends respectively in communication with the compartment of the floating body and the chamber of the pressure resistant member, with the pump connected to the inlet valve.

4. The self-powered air-floating carrier as claimed in claim 3, with the adjusting assembly further including at least one sensor connected to a side of the pump, with the at least one sensor detecting a temperature and a pressure of the gas in the compartment of the floating body.

5. The self-powered air-floating carrier as claimed in claim 3, with the adjusting assembly further including two sensors respectively connected to two sides of the pump, with the two sensors respectively located in the chamber and the compartment.

6. The self-powered air-floating carrier as claimed in claim 1, with the temperature controlling unit including a heat collection member and a heating member, with the heat collection member mounted to an outer periphery of the floating body, with the heating member extending into the chamber of the pressure resistant member and abutting the inner periphery of the pressure resistant member.

7. The self-powered air-floating carrier as claimed in claim 1, with the insulating layer annularly located on the outer periphery of the pressure resistant member, with the insulating layer made of thermally insulating material or structure.

8. The self-powered air-floating carrier as claimed in claim 1, with a bracket unit mounted to the pressure resistant member, with the bracket unit including first and second ends, with the first end of the bracket unit carrying the pressure resistant member, with the second end of the bracket unit fixed to the inner periphery of the floating body at a location corresponding to the support.
